(19) United States
(12) Patent Application Publication
(10) Pub. No.: US 2024/0049784 A1
(43) Pub. Date: Feb. 15, 2024

(54) DUAL VAPORIZER MIXING SYSTEM

(71) Applicants: Daneen Solomon, Anaheim, CA (US); Numair Fakir, Brea, CA (US)

(72) Inventors: Daneen Solomon, Anaheim, CA (US); Numair Fakir, Brea, CA (US)

(21) Appl. No.: 17/884,812

(22) Filed: Aug. 10, 2022

(51) Int. Cl. A24F 40/30; B01F 23/10; A24F 7/00; A24F 40/485; A24F 40/10; A24F 40/60; F16K 11/074

(52) U.S. Cl. CPC A24F 40/30; B01F 23/191; B01F 23/12; A24F 7/00; A24F 40/485; A24F 40/10; A24F 40/60; F16K 11/074

(57) ABSTRACT

A dual vaporizer mixing system has a vapor generator with a first chimney and a second chimney. The first chimney generates a first vapor column having a first flavor, and the second chimney generates a second vapor column having a second flavor. A regulator is connected to the vapor generator and receives vapor from the vapor generator. A mouthpiece is connected to the regulator and receives vapor from the regulator. A flavor selector is swivel mounted to a swivel joint. The swivel joint is formed on the regulator. The flavor selector has a first flavor selection that allows passage of the first vapor column through the regulator. The flavor selector has a second flavor selection that allows passage of the second vapor column through the regulator.

### FIELD OF THE INVENTION

The present invention is in the field of electronic vaporizers.

### DISCUSSION OF RELATED ART

A variety of different electronic vaporizers have been created in the prior art. Combining electronic vaporizers for different flavors traditionally has been done by using two separate electronic vaporizers and alternatively inhaling from both or inhaling one from one side of the mouth and inhaling the other from the other side of the mouth. Flavor mixing has also been done by combining multiple independent electronic vaporizers into a combination chassis with a mouthpiece adapter.

### SUMMARY OF THE INVENTION

A dual vaporizer mixing system has a vapor generator with a first chimney and a second chimney. The first chimney generates a first vapor column having a first flavor, and the second chimney generates a second vapor column having a second flavor. A regulator is connected to the vapor generator and receives vapor from the vapor generator. A mouthpiece is connected to the regulator and receives vapor from the regulator. A flavor selector is swivel mounted to a swivel joint. The swivel joint is formed on the regulator. The flavor selector has a first flavor selection that allows passage of the first vapor column through the regulator. The flavor selector has a second flavor selection that allows passage of the second vapor column through the regulator. The flavor selector has an intermediate flavor selection between the first flavor selection and the second flavor selection which allows a measured proportion of the first vapor column and the second vapor column through the regulator. The vapor generator further includes a first generator chamber and a second generator chamber. The first generator chamber stores first chimney vapor liquid for the first chimney, and the second generator chamber stores second chimney vapor liquid for the second chimney.

Preferably, the first chimney passes through the first generator chamber, and the second chimney passes through the second generator chamber. The dual vaporizer mixing system also preferably includes a flavor selector with a first flavor indicator and a second flavor indicator. The flavor selector is preferably formed with a flavor selector slider, so that the flavor selector slider is formed as a flavor slider handle that rotates within a flavor slot. The flavor selector slider is connected to a valve plate. The valve plate regulates passage of the first vapor column through the regulator and passage of the second vapor column through the regulator. The valve plate is formed as a semicircular plate with a first valve plate cutout and a second valve plate cutout. Optionally, the first valve plate cutout and the second valve plate cutout are semicircular. The valve plate swivel joint is formed between the first valve plate cutout and the second valve plate cutout.

The first valve plate cutout is semicircular. The second valve plate cutout is semicircular. The valve plate swivel joint is formed between the first valve plate cutout and the second valve plate cutout. The first valve plate cutout blocks part of the first chimney by constricting the first vapor column when the flavor selector slider is rotated partially towards the second flavor. The second valve plate cutout blocks part of the second chimney by constricting the second vapor column when the flavor selector slider is rotated partially towards the first flavor.

It is an object of the present invention to allow flavor selection during an inhale of the vaporizer. For example, a user can start off with strawberry at the beginning of an inhale and and with banana at the end of an inhale. Alternatively, the user could start off with banana at the beginning of an inhale and with strawberry at the end of an inhale. The user can slide the flavor selector while inhaling. The user can also alternate between strawberry and banana several times during inhalation. This allows endless flavor vapor inhaling experimentation.

### BRIEF DESCRIPTION OF THE DRAWINGS

FIG. 1 is a perspective view of the present invention.

FIG. 2 is a cross-section diagram showing operation of the valve.

FIG. 3 is a cross-section diagram showing operation of the valve.

FIG. 4 is a perspective view of the valve plate.

FIG. 5 is a cross section view of the vaporizer.

The following callout list of elements can be a useful guide in referencing the element numbers of the drawings.
20 mouthpiece
21 mouthpiece outlet
30 regulator
31 first flavor indicator
32 second flavor indicator
33 flavor slot
34 flavor slider
35 regulator inlet
36 regulator outlet
37 valve mounting area
38 flavor slider
40 vapor generator
41 first generator chamber
42 second generator chamber
43 first chimney
44 second chimney
45 housing
46 partition
47 swivel joint
50 electrical heater
51 electrical heater contacts
52 heater coils
53 first vapor column
54 second vapor column
60 valve plate
61 valve plate swivel joint
62 first valve plate cutout
63 second valve plate cutout
64 outside valve plate sidewall
65 inside valve plate sidewall
66 valve plate upper side
67 mixing chamber
68 mixing chamber outlet

### DETAILED DISCUSSION OF THE PREFERRED EMBODIMENT

The present invention is an electronic cigarette that has dual vaporization capability and has a flavor selection with a flavor dial controlling a valve for mixing two flavors. The dual vaporization has a pair of different flavors. The flow rate of the vapor flavors are controlled to a specific proportion using a flavor slider control mounted on a housing of the electronic cigarette device.

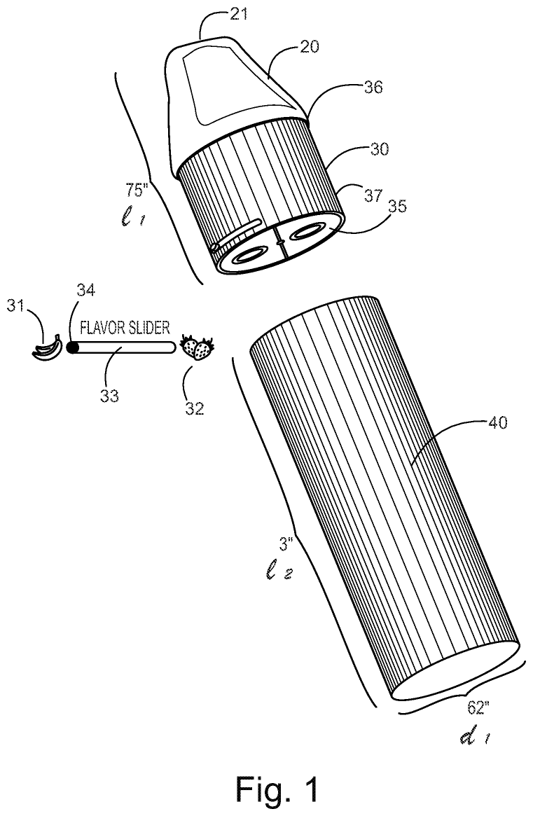

As seen in FIG. 1, the mouthpiece 20 has a mouthpiece outlet 21 receiving a user inhale. The mouthpiece 20 has fluid flow through it in a mouthpiece conduit that connects from the mouthpiece outlet 21 to the regulator outlet 36 of the regulator 30. The mouthpiece 20 is preferably tapered for a user's lips and is plastic injection molded.

The regulator 30 can be formed as a cylinder that has a regulator inlet 35 in fluid flow to a regulator outlet 36. The regulator inlet 35 can have a pair of vapor inlets that combine to a regulator outlet 36. The mouthpiece outlet 21 can be a smaller opening than the regulator inlet 35. The regulator inlet 35 can have a larger cross-section than the regulator outlet 36. The regulator 30 has a flavor selection control. The flavor selection control includes a first flavor indicator 31 and a second flavor indicator 32. Preferably, a flavor slider handle 34 protrudes from a flavor slot 33. The flavor slider handle 34 moves in a rotary fashion. The flavor slider handle 34 of the flavor slider 38 can be mounted in the valve mounting area 37 above the vapor generator 40.

A user selects between a first flavor indicator 31 and a second flavor indicator 32 by sliding the flavor slider handle 34 in the flavor slot 33. For example, if the first flavor is banana and the second flavor is strawberry, then the first flavor indicator 31 can be a banana icon and the second flavor indicator 32 can be a strawberry icon. The user inputs the flavor selection by rotating the flavor slider handle 34 to select the flavor composition or flavor mix. The user moves the handle all the way to the first flavor indicator 31 as seen in FIG. 1 to select the first flavor. The user could also move the handle all the way to the second flavor indicator 32 to select the second flavor.

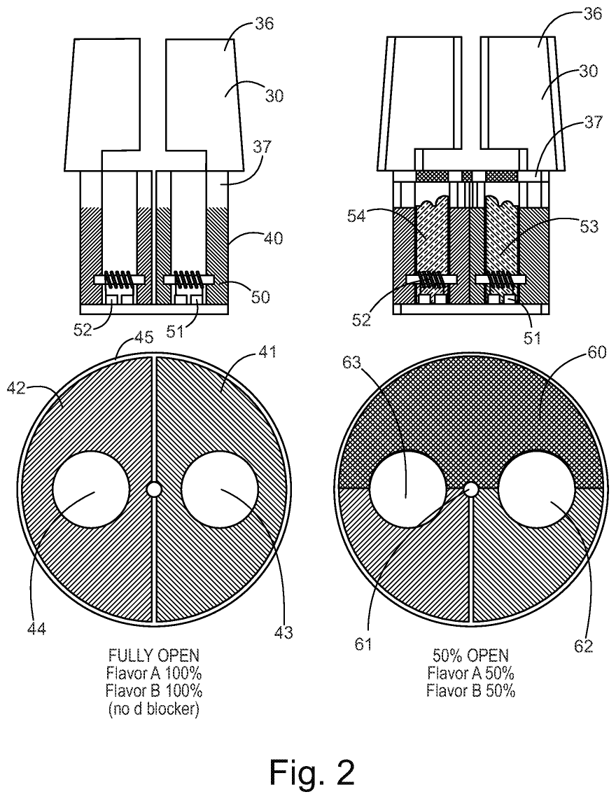

As seen in FIG. 2, the mounting area 37 can be formed as a hollow disc-shaped slot for holding the valve plate. The vapor generator 40 can be attached to the regulator 30, or attached by magnets. The vapor generator 40 has a first generation chamber 41 and a second generation chamber 42 where fluid to be atomized is being stored. The flu can be a gel. The vaporization fluid travels into the electrical heater 50 and electrical heater contacts 51 provide electrical power for the electrical heater 50. The electrical heater 50 is preferably a resistance heater having heater coils 52.

The first generator chamber 41 has a first chimney 43 and the second generator chamber 42 has a second chimney 44. The housing 45 can be cylindrical so that the first generator chamber 41 and the second generator chamber 42 are semicircular with a bisecting partition 46 between them. A swivel joint 47 is preferably mounted on the partition 46. The swivel joint 47 can be a vertically oriented cylindrical opening that receives a metal bolt or stud.

The first vapor column 53 forms in the first chimney 43 and the second vapor column 54 forms in the second chimney 44 when the electrical heaters 50 receives vapor fluid from the first generation chamber 41 or the second generation chamber 42. The electrical heaters 50 can have fabric or fiber wicking such as ceramic fiber or fiberglass fiber with the electrical heater wrapped around the fibrous core. As the fluid is vaporized due to the heat, the fluid generates a vapor column that is retained within the chimney.

The valve plate 60 controls the flow of the vapor column through the regulator 30. The valve plate 60 has a first valve plate cutout 62 and a second valve plate cutout 63. The valve plate swivel joint 61 is formed between the first valve plate cutout 62 and the second valve plate cutout 63. The valve plate 60 fits within the regulator 30 at the valve mounting area 37. The valve mounting area 37 is near the regulator inlet 35 and a lower portion of the regulator. The battery has electrical contact with the electrical heater contacts 51. The valve plate 60 has a valve plate swivel joint 61 which can be an opening or swivel cutout that receives a pin or axle. The user can rotate the valve plate 60 inside the housing because the housing is cylindrical and receives the valve plate 60 in a rotational configuration. The first valve plate cutout 62 and the second valve plate cutout 63 are both semicircular or half circles while the valve plate 60 is also a semi circle or half circle.

The valve plate 60 can be removed for a fully open position or can be installed for allowing a half open position with 50 percent of a first flavor and 50 percent of a second flavor.

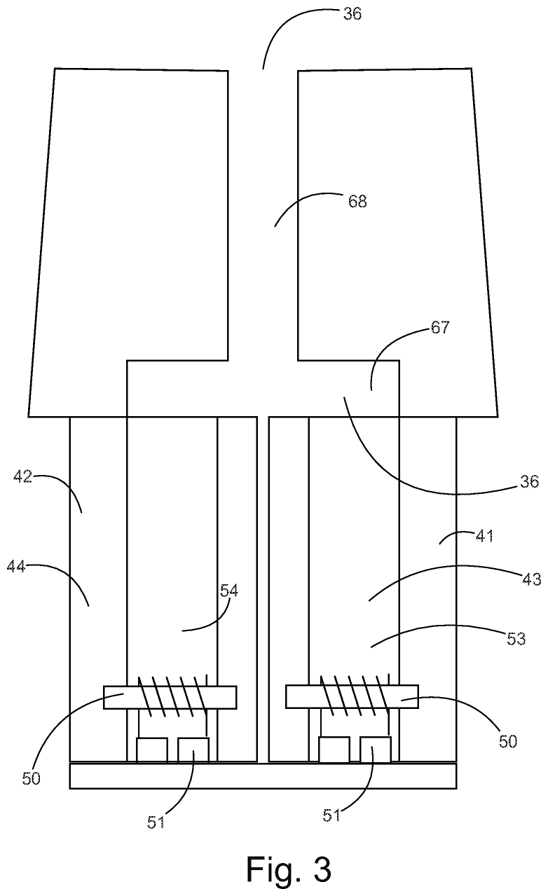

As seen in FIG. 3, the mixing chamber 67 is located above the valve plate 60 so that fluid flow such as airflow or vapor flow to the mixing chamber outlet 68 passes from the mixing chamber 67 to the mixing chamber outlet 68 before exiting through the regular outlet 36. The first generator chamber 41 and the second generator chamber 42 can be vertically oriented and parallel to each other. A pair of electric heaters 50 each have a pair of electrical heater contacts 51 that are connected to the battery for electrical power. The first vapor column 53 and the second vapor column 54 are also parallel to each other in an elongated vertically oriented configuration.

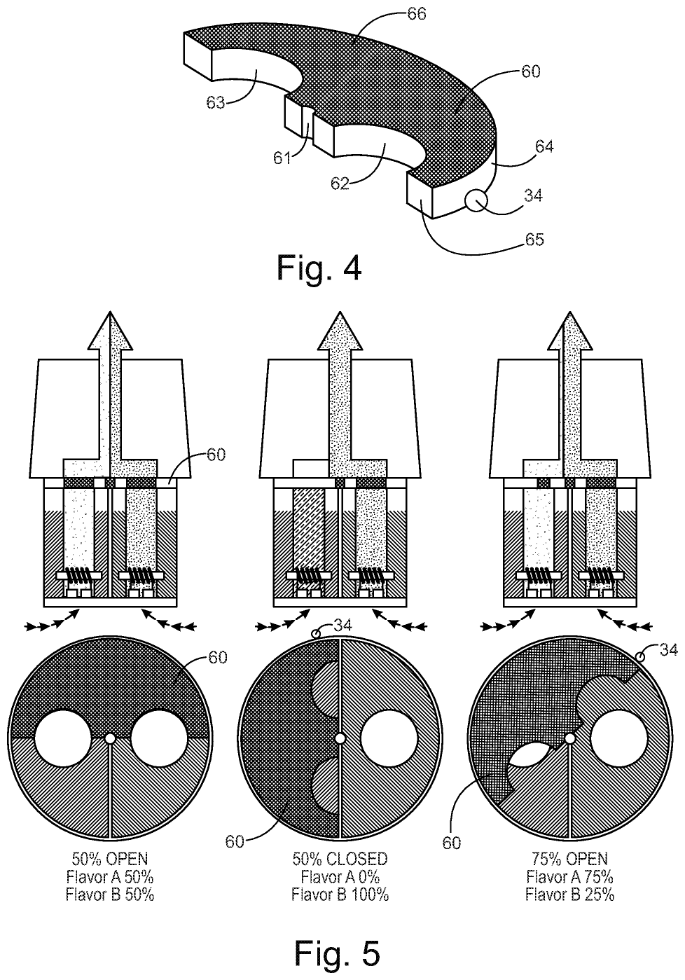

As seen in FIG. 4, the flavor slider handle 34 is formed as a knob that is connected to the valve plate 60 at an outside valve plate sidewall 64. The valve plate 60 has a thickness with a sidewall that passes around its circumference. The valve plate upper side 66 is in the direction of the airflow and airflow passes over the top of the valve plate upper side 66. The valve plate 60 has a valve plate swivel joint 61 formed as a semicircular slot in an inside valve plate sidewall 65. The first valve plate cutout 62 and the second valve plate cutout 63 are parallel to the semicircular slot of the valve plate swivel joint 61. The outside valve plate sidewall 64 is a half circle which defines the half circle profile of the valve plate upper side 66. Similarly, the valve plate swivel joint 61, the first valve plate cutout 62 and the second valve plate cutout 63 are also have circles in cross-section.

As seen in FIG. 5, the flavor slider handle 34 is rigidly connected to the valve plate 60. As a user moves the flavor slider handle 34, the vapor flavor changes and the user can experiment with different flavor combinations. Sometimes even a slight hint of a second flavor can provide an improved user experience.

1. A dual vaporizer mixing system comprising:
a. a vapor generator, wherein the vapor generator has a first chimney and a second chimney, wherein the first chimney generates a first vapor column having a first flavor, and wherein the second chimney generates a second vapor column having a second flavor;
b. a regulator, wherein the regulator is connected to the vapor generator and receives vapor from the vapor generator;
c. a mouthpiece, wherein the mouthpiece is connected to the regulator and receives vapor from the regulator; and
d. a flavor selector, wherein the flavor selector is swivel mounted to a swivel joint, wherein the swivel joint is formed on the regulator, wherein the flavor selector has a first flavor selection that allows passage of the first vapor column through the regulator, wherein the flavor selector has a second flavor selection that allows passage of the second vapor column through the regulator, wherein the flavor selector has an intermediate flavor selection between the first flavor selection and the second flavor selection which allows a measured proportion of the first vapor column and the second vapor column through the regulator.

2. The dual vaporizer mixing system of claim 1, wherein the vapor generator further includes a first generator chamber and a second generator chamber, wherein the first generator chamber stores first chimney vapor liquid for the first chimney, wherein the second generator chamber stores second chimney vapor liquid for the second chimney.

3. The dual vaporizer mixing system of claim 2, wherein the first chimney passes through the first generator chamber, wherein the second chimney passes through the second generator chamber.

4. The dual vaporizer mixing system of claim 1, wherein the flavor selector has a first flavor indicator and a second flavor indicator.

5. The dual vaporizer mixing system of claim 1, wherein the flavor selector is formed with a flavor selector slider, wherein the flavor selector slider is formed as a flavor slider handle that rotates within a flavor slot.

6. The dual vaporizer mixing system of claim 5, wherein the flavor selector slider is connected to a valve plate, wherein the valve plate regulates passage of the first vapor column through the regulator and passage of the second vapor column through the regulator.

7. The dual vaporizer mixing system of claim 6, wherein the valve plate is formed as a semicircular plate with a first valve plate cutout and a second valve plate cutout.

8. The dual vaporizer mixing system of claim 7, wherein the first valve plate cutout is semicircular.

9. The dual vaporizer mixing system of claim 7, wherein the second valve plate cutout is semicircular.

10. The dual vaporizer mixing system of claim 7, wherein the valve plate swivel joint is formed between the first valve plate cutout and the second valve plate cutout.

11. The dual vaporizer mixing system of claim 7, wherein the first valve plate cutout is semicircular; wherein the second valve plate cutout is semicircular; wherein the valve plate swivel joint is formed between the first valve plate cutout and the second valve plate cutout, wherein the first valve plate cutout blocks part of the first chimney by constricting the first vapor column when the flavor selector slider is rotated partially towards the second flavor, wherein the second valve plate cutout blocks part of the second chimney by constricting the second vapor column when the flavor selector slider is rotated partially towards the first flavor.

12. The dual vaporizer mixing system of claim 7, wherein the valve plate swivel joint is formed between the first valve plate cutout and the second valve plate cutout, wherein the valve plate blocks part of the first chimney by constricting the first vapor column when the flavor selector slider is rotated partially towards the second flavor, wherein the valve plate cutout blocks part of the second chimney by constricting the second vapor column when the flavor selector slider is rotated partially towards the first flavor.

13. The dual vaporizer mixing system of claim 12, wherein the vapor generator further includes a first generator chamber and a second generator chamber, wherein the first generator chamber stores first chimney vapor liquid for the first chimney, wherein the second generator chamber stores second chimney vapor liquid for the second chimney.

14. The dual vaporizer mixing system of claim 12, wherein the first chimney passes through the first generator chamber, wherein the second chimney passes through the second generator chamber.

15. The dual vaporizer mixing system of claim 12, wherein the flavor selector has a first flavor indicator and a second flavor indicator.

16. The dual vaporizer mixing system of claim 12, wherein the flavor selector is formed with a flavor selector slider, wherein the flavor selector slider is formed as a flavor slider handle that rotates within a flavor slot.
